(19) United States
(12) Patent Application Publication
(10) Pub. No.: US 2022/0174548 A1
(43) Pub. Date: Jun. 2, 2022

(54) ADMINISTRATIVE STATES OF SLICES

(71) Applicant: NOKIA TECHNOLOGIES OY, ESPOO (FI)

(72) Inventors: Jürgen GOERGE, Neuried (DE); Jann ALI-TOLPPA, Taufkirchen (DE)

(21) Appl. No.: 17/599,117

(22) PCT Filed: Apr. 1, 2019
(86) PCT No.: PCT/EP2019/058204

§ 371 Date: Sep. 28, 2021

(51) Int. Cl. H04W 28/16; H04L 41/5051; H04W 48/02

(52) U.S. Cl. CPC H04W 28/16; H04W 48/02; H04L 41/5051

(57) ABSTRACT

It is provided a method, comprising supervising if a first indication comprising a value of a first management information of a first instance of a first network function related to a first slice is received; setting the value of the first management information of the first instance of the first network function related to the first slice according to the first indication if the first indication is received.

### FIELD OF THE INVENTION

The present invention relates to network slicing. In a particular case, it relates to administrative states related to network slices.

### Abbreviations

3GPP 3^{rd} Generation Partnership Project
3G/4G/5G 3^{rd}/4^{th}/5^{th} Generation
AMF Access and Mobility Management Function
AN Access Network
AST Administrative State
BTS Base Transceiver Station
gNB gNodeB (base station of 5G)
Id Identifier
IOC Information Object Class
IoT Internet of Things
ITU-T International Telecommunication Union—Telecommunication Standardization Sector
LTE Long-term Evolution
MIM Management Information Model
MO Managed Object
MOC Managed Object Class
NF Network Function
NRM Network Resource Model
NSI Network Slice Instance
NSSF Network Slice Selection Function
NSSI Network Slice Subnet Instance
OAM Operation and Maintenance
PLMN Public Land Mobile Network
RAN Radio Access Network
SD Service Differentiator
SMF Session Management Function
S-NSSAI Single Network Slice Selection Assistant Information
SST Slice/Service Type
TS Technical Specification
UDM Unified Data Management
UE User Equipment
UMF User Management Function

### Glossary

MO=Managed Object (from 3GPP TS 32.622): A Managed Object is a software object that encapsulates the manageable characteristics and behaviour of a particular Network Resource. See also the definition of MO in 3GPP TS 32.101. The MO is an instance of a MO class (MOC) defined in a MIM/NRM. This class, in the context of an Information Service specification called Information Object Class (10C), has attributes that provide information used to characterize the objects that belong to the class. Furthermore, an MO class can have operations that represent the behaviour relevant for that class. An MO class may support notifications that provide information about an event occurrence within a network resource.
NSI=Network Slice Instance (from 3GPP TS 28.541): Object instance representing a slice in management applications/management services
NSSI=Network Slice Subnet Instance (from 3GPP TS 28.541): Object instance representing a SubNetwork, that is associated to a network slice
S-NSSAI=Single Network Slice Selection Assistant Information (from 3GPP TS23.501): Identifier that the 5G network uses to uniquely identify a network slice end-2-end in signalling.

### BACKGROUND OF THE INVENTION

Mobile networks like LTE or 5G shall be enabled to share the physical resources to offer multiple virtual networks to the users. These virtual networks, called “slices”, shall be designed to offer specific properties like high bandwidth, low latency, or to support a huge number of IoT devices. These slices shall serve different tenants with different service level agreements. Therefore, the network must be able to isolate the slices from each other. To be able to offer these virtual networks on demand, it shall be possible to create, activate, de-activate and delete such slices quickly.

To manage mobile networks that are offering slices, 3GPP has defined a network resource model for slices (3GPP TS 28.541). In this model the managed object classes “NetworkSlice” and “NetworkSliceSubnet” are exposing the attribute “Administrative State” with the allowed values: “Locked”, “Unlocked” or “Shuttingdown”, as defined in 3GPP TS 28.625 and ITU-T X.731. It describes the permission to use or prohibition against using instances of the managed objects imposed through the OAM services. The object classes “NetworkSlice” and “NetworkSliceSubnet” are collections of many network functions. Conventionally, the administrative state has been applied to individual resources only. It is not defined how the Administrative State of collections of objects shall behave.

To “Lock” and “Unlock” a slice in its entirety from one single management system is a valid use case from operator's point of view and might be used e.g. in following situations:
The overall slice requires many different resources that all must be configured properly to form a running slice. Therefore, the operator needs to prepare and configure all relevant resources before the slice can be released for public use. During this work, the operator wants to block any traffic from the slice. Once all constituents of the slice are ready, the operator wants to unlock the slice.
The operator wants to “Lock”/“Unlock” the slice temporarily, without the need to de-commission/de-configure the slice.

It is recommendable that the behaviour of the administrative states of the different entities is standardized to guarantee a well-defined behaviour for all entities involved in selection and assigning a slice to a UE.

### REFERENCES

3GPP TS23.501 “System Architecture for the 5G System”
3GPP TS28.541 “Management and orchestration; 5G Network Resource Model (NRM)”

### SUMMARY OF THE INVENTION

It is an object of the present invention to improve the prior art.

According to a first aspect of the invention, there is provided an apparatus, comprising first means for setting configured to set a value of a first administrative state of a network function related to a first slice; second means for setting configured to set a value of a second administrative state of the network function related to a second slice, wherein the first slice is different from the second slice.

According to a second aspect of the invention, there is provided an apparatus, comprising means for supervising configured to supervise if a first indication comprising a value of a first management information of a first instance of a first network function related to a first slice is received; means for setting configured to set the value of the first management information of the first instance of the first network function related to the first slice according to the first indication if the first indication is received.

According to a third aspect of the invention, there is provided an apparatus, comprising means for informing configured to inform a second instance of a second network function different from a first instance of a first network function by a value information, wherein the value information informs on a value of a first management information of the first instance of the first network function related to the first slice.

According to a fourth aspect of the invention, there is provided a method, comprising setting a value of a first administrative state of a network function related to a first slice; setting a value of a second administrative state of the network function related to a second slice, wherein the first slice is different from the second slice.

According to a fifth aspect of the invention, there is provided a method, comprising supervising if a first indication comprising a value of a first management information of a first instance of a first network function related to a first slice is received; setting the value of the first management information of the first instance of the first network function related to the first slice according to the first indication if the first indication is received.

According to a sixth aspect of the invention, there is provided a method, comprising informing a second instance of a second network function different from a first instance of a first network function by a value information, wherein the value information informs on a value of a first management information of the first instance of the first network function related to the first slice.

Each of the methods of the fourth to sixth aspects may be a method of managing an administrative state of a slice.

According to a seventh aspect of the invention, there is provided a computer program product comprising a set of instructions which, when executed on an apparatus, is configured to cause the apparatus to carry out the method according to any of the fourth to sixth aspects. The computer program product may be embodied as a computer-readable medium or directly loadable into a computer.

According to some example embodiments of the invention, at least one of the following advantages may be achieved:
Network slices are separated with respect to their administrative state, i.e., a change of the operational state of one slice does not affect the operational state of another slice;
Operator use cases for quickly setting up/dismantling slices are supported.

Further advantages become apparent from the following detailed description.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred example embodiments of the present invention which is to be taken in conjunction with the appended drawings, wherein:

FIG. 1a shows an improper handling of the AST;

FIG. 1b shows a proper handling of the AST according to some example embodiments of the invention;

FIG. 2a shows a proper management of the system according to some example embodiments of the invention;

FIG. 2b shows an improper management of the system;

FIG. 3 shows a proper management of the system according to some example embodiments of the invention;

FIG. 4 shows an apparatus according to an example embodiment of the invention;

FIG. 5 shows a method according to an example embodiment of the invention;

FIG. 6 shows an apparatus according to an example embodiment of the invention;

FIG. 7 shows a method according to an example embodiment of the invention;

FIG. 8 shows an apparatus according to an example embodiment of the invention.

FIG. 9 shows a method according to an example embodiment of the invention; and

FIG. 10 shows an apparatus according to an example embodiment of the invention.

### DETAILED DESCRIPTION OF CERTAIN EXAMPLE EMBODIMENTS

Herein below, certain example embodiments of the present invention are described in detail with reference to the accompanying drawings, wherein the features of the example embodiments can be freely combined with each other unless otherwise described. However, it is to be expressly understood that the description of certain example embodiments is given by way of example only, and that it is by no way intended to be understood as limiting the invention to the disclosed details.

Moreover, it is to be understood that the apparatus is configured to perform the corresponding method, although in some cases only the apparatus or only the method are described.

It is not clear how the network functions associated to a “NetworkSlice” and “NetworkSliceSubnet” shall behave in order to enforce the network-wide permission or prohibition of “NetworkSlice” or “NetworkSliceSubnet”. 3GPP has also not defined how these associated network functions are informed about the state, especially if the network functions are managed by separated management functions.

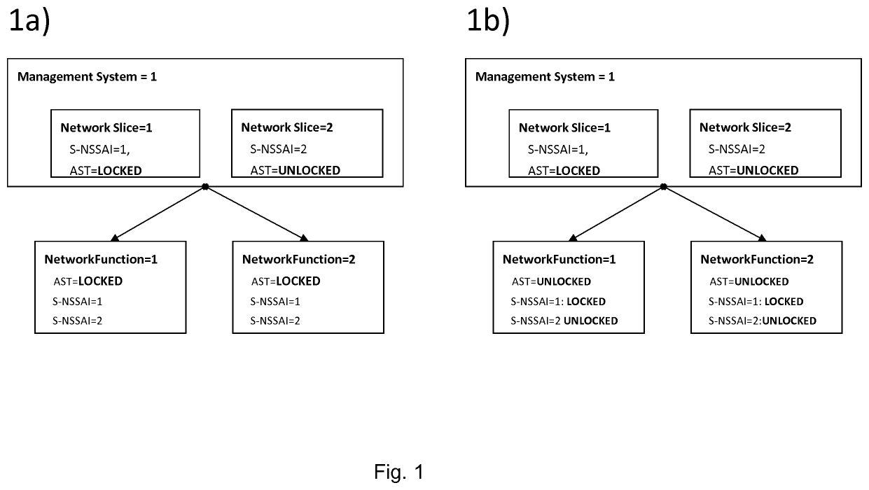

In general, it would be improper if locking a given slice object (Network Slice=1) would result in locking each associated resource (e.g. NetworkFunction=1 and NetworkFunction=2) as a whole, because the resources might be associated to multiple slice objects (e.g. Network Slice=1 and Network Slice=2) which shall be isolated against each other. Such an improper approach is shown in FIG. 1a. In a proper approach, locking one slice object must not impact other slices as a side effect. Therefore, according to some embodiments of the invention, the Network Functions handle the administrative state per individual slice, as shown in FIG. 1b. The slices in the network are identified by their S-NSSAI.

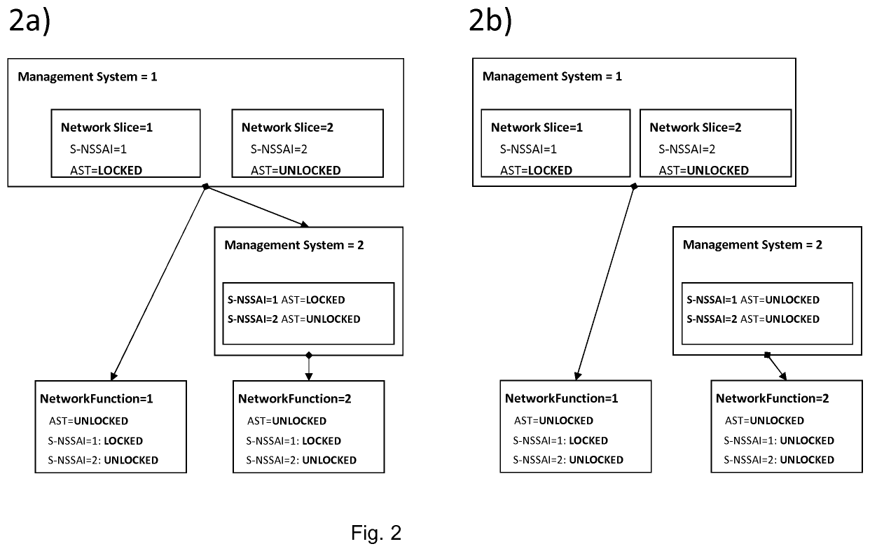

Setting the administrative state should preferably work in situations where the different constituents of the slice are provided by different vendors or are managed by different management systems. If one management system controls the whole network (end-to-end, directly or indirectly via subordinated management systems), then the management system is able to address all associated network functions to set the administrative state for the network function as such and for each slice identified by their S-NSSAI (cf. FIG. 2a).

In case some network functions are associated e.g. by their S-NSSAI to a given network slice, but are managed by a different, separated management system, no instance in the system is able to enforce the administrative state across all network functions associated to a network slice (cf. FIG. 2b). E.g. gNBs, AMF, and SMF might be configured to serve the same slice, but might be managed by different management systems. Currently this might be the most probable case, because mobile network operators still are using multiple different management systems that might not offer a seamless end-to-end management across all network domains and all network elements. In such a situation, the originating management system (e.g. management System 1 in FIG. 2b) might not be able to communicate the value of the administrative state to the associated resources. As a result the setting of the administrative state might be inconsistent and one or more network functions might not enforce the slice to be locked (e.g. S-NSSAI=1 is not locked at NetworkFunction=2 in FIG. 2b).

According to some example embodiments of the invention, the behavior of the “Administrative State” is well defined for all network functions involved in handling a given slice. All network functions that are handling a given S-NSSAI are involved to contribute at least partially to a given slice. In the following a non-exhaustive list of functions that are particularly involved in the handling of the administrative state:
Network Management System(s)
(Radio) Access Network
AMF
NSSF
SMF

Many resources, including the standardized MOC NetworkSliceSubnet might be shared among multiple NetworkSlices which must be isolated against each other. Therefore, according to some example embodiments of the invention, all resources that potentially are shared between several slices are able to handle the administrative state per slice. For shared resources, it would be incorrect (improper) to lock the resource as a whole (see the example of FIG. 1a). Instead, only those parts must be locked, that are related to the locked Network Slice identified by its S-NSSAI (see the example of FIG. 1b).

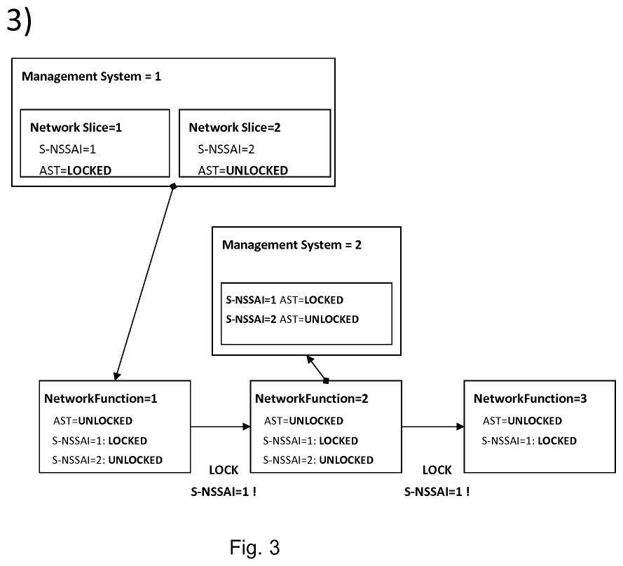

According to some example embodiments of the invention, the administrative state of a given network slice is propagated to all network functions that are handling the corresponding S-NSSAI. The overall system enforces this in case of
a) Central Management of the administrative state: If the associated resources are managed by the originating management system, either directly or indirectly via subordinated management systems (see e.g. FIG. 2a): The interfaces (“services”) of the management systems are enabled to manage the administrative state per slice (i.e. per S-NSSAI).
b) Distributed Management of the administrative state: To cover situations where the resources of a given slice are managed by separate management systems (see e.g. FIG. 2b), according to some example embodiments of the invention, the signaling interfaces between some of the network functions are enhanced in such a way that the network functions inform each other about the administrative state of the slice or a change thereof (see FIG. 3). Upon reception of a message indicating an administrative state of a network function related to a particular slice, the receiving network function sets the administrative state for this particular slice (S-NSSAI) accordingly. Furthermore, the receiving network function may inform its management system, and may inform other managed functions of the administrative state related to the particular slice, too.

Such exchange of management information via a meshed network of the network functions/services might be useful to distribute other management information too. E.g. the network functions might exchange information about their operational state or about their status regarding tests.

Hereinafter, the behavior of some network functions with respect to the administrative state according to some example embodiments of the invention is described more in detail.

### Impact to Management Systems (e.g. 3GPP Management Systems):

Management Systems according to some example embodiments of the invention handle the administrative state of at least one network function per slice.

Management systems according to 3GPP TS 28.541 model a slice by the IOC NetworkSlice and identify the type of a slice by the attribute SST (“Slice/Service Type”) and by a set of associated IOC ServiceProfiles, each containing a list of S-NSSAI, each item of the list containing a SST and a SD (“Service Differentiatior”).

The IOC NetworkSlice is associated to exactly one instance of IOC NetworkSliceSubnet which also has an attribute SST and a set of associated SliceProfile (attribute sliceProfileList), which again holds a list of S-NSSAI, each item of the list containing a SST and a SD.

The toplevel instance of NetworkSliceSubnet (1:1 associated with IOC NetworkSlice) recursively might associate other IOC NetworkSliceSubnet, ManagedFunctions (i.e. network functions, resources), and/or a NetworkService. These non-toplevel objects might be shared by multiple slices. Therefore, according to some example embodiments of the invention, these IOC are enhanced to handle the administrative state per slice (S-NSSAI) in order to allow for isolation of different slices.

Note: This per-slice administrative state proposed for NetworkSliceSubnet is different from the currently existing administrative state of the IOC NetworkSliceSubnet: The existing administrative state of NetworkSliceSubnet holds for this whole instance of NetworkSliceSubnet. This semantics is not well-defined yet (see above). It is not clear whether administrativeState=locked of the NetworkSliceSubnet implies that all associated resources (NetworkSliceSubnets, ManagedFunctions, and NetworkServices) as a whole are locked, too. This might be the case because there is no requirement for isolation between NetworkSliceSubnets. This would imply that locking one NetworkSliceSubnet might impact the service of many NetworkSliceSubnets and NetworkSlices. Similarly, locking a cell (in its entirety) impacts service of all network slices using this cell. Such locking might be required e.g. due to maintenance of the cell.

According to some example embodiments of the invention, the management interfaces between the management systems and between management systems and managed elements convey the administrative state per slice (S-NSSAI). It is recommended that such definitions will be included in 3GPP TS 28.541.

Impact to (Radio) Access Network (e.g. gNB):

UE and gNB identify slices by the S-NSSAI. In order to allow for isolation of slices, according to some example embodiments of the invention, the gNB handles an administrative state per S-NSSAI. If a given slice identified by an S-NSSI has been “locked” by the operator, the gNB handles any request from a UE requesting this slice as if the UE had not provided the S-NSSAI. Basically, in this case, (R)AN shall fall back to a previously defined default slice (default S-NSSAI). If the default slice or even all slices are locked, then the gNB shall reject any attempt for admission.

This behaviour is explained by an example:

Assume the BTS (e.g. gNB) is configured in the following way:
slice=1 is the default slice and is locked,
slice=2 is not default and is unlocked, and
slice=3 is not configured in the BTS at all.

Then, the following scenarios are possible:
If a UE requests slice=1, then it will not get any service because slice=1 is locked.
If a UE requests slice=2, then it will get slice=2.
If a UE requests slice=3, then the BTS usually would try to assign the UE to the default slice, i.e. slice=1. Since slice=1 is locked, the UE will not get any service.

### Impact to Access and Mobility Function (AMF):

In order to allow for isolation of slices, according to some example embodiments of the invention, the AMF handles an administrative state per S-NSSAI. In case a gNB signals an initial attach of a UE for a locked S-NSSAI, the AMF suppresses this S-NSSAI, and proceeds as if this S-NSSAI had not been provided by the UE (via gNB). That is, the AMF does not provide any service for this specific slice. The AMF does not query any other network function (e.g. User Management Function (UMF), Network Slice Selection Function (NSSF), etc) regarding the locked S-NSSAI.

In some example embodiments of the invention, if the AMF knows by some means that another slice might offer the same service, and that the UE is allowed to use this service by the other slice (e.g. due to a query to User Data Management in Unified Data Repository), then the AMF may assign the other slice to the UE instead. This behavior is similar to a roaming case, where UE might request SST and SD which are not supported by the visiting network. But the visiting network might be aware of how to map the unsupported SST/SD to SST/SD that are supported in the network and that offer the same service (and that according to the roaming agreement the UE is allowed to use).

In case a UE already had been assigned to a slice before the operator locks the slice, according to some example embodiments of the invention, the AMF deletes the S-NSSAI from the UE (3GPP TS23.501 clause 5.15.4.2 “Update of UE Network Slice Configuration”).
Note: 3GPP also offers the AMF to “reject” a S-NSSAI for a UE per PLMN or per registration area. However, this might not be proper means to enforce the administrative state: The AMF can only reject during registration of an UE, i.e. “reject” would not drive UE out of a slice if the slice is locked later, after registration. Further, if a given S-NSSAI was rejected, then the UE shall store this S-NSSAI in the “rejected NSSAI” list and must not retry this S-NSSAI until the S-NSSAI gets deleted from the list. As a consequence, to unlock a S-NSSAI, the AMF has to delete and to re-create the S-NSSAI from UE point of view anyway.

In short, according to some example embodiments of the invention, the AMF proceeds according to at least one of the following behaviors if it receives a query (request) related to a locked S-NSSAI:
In case of an initial attach of UE: the AMF suppresses this S-NSSAI, and proceeds as if this S-NSSAI had not been given by the UE. In particular:
   AMF does not query any other NF (UDM, NSSF) regarding the locked S-NSSAI; and/or
   AMF rejects any PDU Session Establishment Request regarding the locked S-NSSAI.
In case a UE already is assigned to a slice: The AMF initiates a change of the S-NSSAI, i.e. AMF signals to the UE that the slice is not available anymore.

### Impact to Network Slice Selection Function (NSSF):

In order to allow for isolation of slices, according to some example embodiments of the invention, the NSSF handles an administrative state per S-NSSAI. In case an AMF signals an initial attach of an UE for a locked S-NSSAI to NSSF, the NSSF suppresses this S-NSSAI, and proceeds as if this S-NSSAI had not been provided by the UE. I.e., NSSF replies that the slice is not available. In particular, the NSSF shall not query any other network function regarding the locked S-NSSAI.

In case a UE already had been assigned to a slice before the slice was locked: According to some example embodiments of the invention, the NSSF initiates a change of the slice, i.e. withdraws the S-NSSAI from the allowed and configured S-NSSAIs. Thus, the UE is informed that the slice is not available anymore.

### Impact to Session Management Function (SMF):

In order to allow for isolation of slices, according to some example embodiments of the invention, the SMF handles an administrative state per S-NSSAI. In case an SMF receives any Nsmf_PDU_CreateSMContextRequest (a request to create a session) regarding a locked S-NSSAI, the SMF rejects the Nsmf_PDU_CreateSMContextRequest regarding the locked S-NSSAI.

According to some example embodiments of the invention, all network functions related to a given S-NSSAI (i.e. providing a service for the slice identified by the given S-NSSAI) may be informed about the value of the administrative state of the slice.

a.) Inform Resources Managed by the Originating Management System

To inform resources managed by the originating management system (i.e., the management initiating a change of the administrative state), either directly or indirectly via subordinated management systems, the management interfaces model an administrative state per slice (S-NSSAI). E.g. the model of 3GPP TS28.541 may be enhanced such that NetworkSliceSubnet is able to handle administrative state per slice. E.g. sNSSAIList in SliceProfile might be enhanced to a list of pairs (S-NSSAI, administrativeState) to express the administrative state per slice. Since the standards still are unclear regarding the proper handling of S-NSSAI, it is not possible to propose a detailed new model right now.

b.) Inform Resources Managed by Different Management Systems

If resources are managed by separate management systems, not connected to the originating management system, the originating management system is not able to communicate the value of the administrative state to the associated resources via management interfaces. In such case, according to some example embodiments of the invention, the network functions may inform each other about the administrative state.
Note: Such exchange of management information via a meshed network of the network functions might be useful to distribute other management information too. E.g. the network functions might exchange information about their operational state or about their status regarding tests.
   Impact to (Radio) Access Network (e.g. gNB):

If the management system locks a slice identified by its S-NSSAI in a gNB, then the gNB may send a message via N2 interface to the related Access Mobility Functions (AMF) to inform the AMF about the value of the administrative state of this slice.

The gNB may be able to receive corresponding messages from the AMF via N2 interface. If receiving such message, the gNB shall set the administrative state of the slice (S-NSSAI) accordingly. Further the gNB may inform other related AMFs via N2 interface.

The gNB may inform neighbouring gNB via the Xn interface about the administrative state, too. However, this easily might cause avalanches of messages, because the gNB do not know which surrounding gNBs already have been informed by other gNBs or AMFs. Therefore, according to some example embodiments of the invention, the gNB (or any other network function) may comprise a list of network functions (or even of instances of network functions) it must not inform of a change of an administrative state of the network function related to a particular slice. The list may depend on the slice or may be one list for all slices. As another option, a receiver of such a message might ignore this message if it had received a corresponding message before. That is, if the received message comprises a same value of the administrative state as the value of the administrative state of the receiver, the receiver does not trigger another message indicating its administrative state.

### Impact to Access and Mobility Function (AMF):

If the AMF receives the information that a slice (S-NSSAI) has been set to administrative state “locked”, then the AMF may send a message to the related network functions of the RAN (e.g. gNB via N2 interface) and/or to the related Network Slice Selection Functions (NSSF) via N22 interface to inform them about the value of the administrative state of this slice.

The AMF may receive corresponding messages from RAN via N2 interface and from NSSF via N22 interface, and, as a result, sets the administrative state of the slice (S-NSSAI) accordingly, and may inform other network functions of the RAN and NSSF, and/or its management system about the administrative state of the slice.

### Impact to Network Slice Selection Function (NSSF):

If the NSSF receives the information that a slice (S-NSSAI) has been set to administrative state “locked”, then the NSSF may send a message to the related network functions (AMF) via N22 interface to inform them about the value of the administrative state of this slice.

The NSSF may receive corresponding messages from AMF, and, as a result, may set the administrative state of the slice (S-NSSAI) accordingly, and may inform other network functions (e.g. AMF), and/or its management system about the administrative state of the slice.

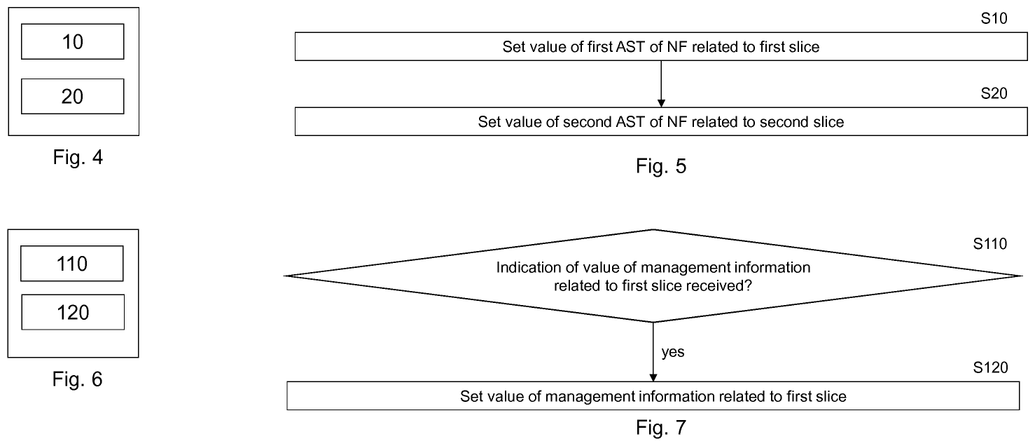

FIG. 4 shows an apparatus according to an example embodiment of the invention. The apparatus may be a management system (e.g. OAM system) or an element thereof. FIG. 5 shows a method according to an example embodiment of the invention. The apparatus according to FIG. 4 may perform the method of FIG. 5 but is not limited to this method. The method of FIG. 5 may be performed by the apparatus of FIG. 4 but is not limited to being performed by this apparatus.

The apparatus comprises first means for setting 10 and second means for setting 20. The first means for setting 10 and second means for setting 20 may be a first setting means and second setting means, respectively. The first means for setting 10 and second means for setting 20 may be a first setter and second setter, respectively. The first means for setting 10 and second means for setting 20 may be a first setting processor and second setting processor, respectively.

The first means for setting 10 sets a value of a first administrative state of a network function related to a first slice (S10).

The second means for setting 20 sets a value of a second administrative state of the network function related to a second slice (S20). The first slice is different from the second slice.

FIG. 6 shows an apparatus according to an example embodiment of the invention. The apparatus may be a network function (e.g. gNB, AMF, NSSF, or SMF) or an element thereof. FIG. 7 shows a method according to an example embodiment of the invention. The apparatus according to FIG. 6 may perform the method of FIG. 7 but is not limited to this method. The method of FIG. 7 may be performed by the apparatus of FIG. 6 but is not limited to being performed by this apparatus.

The apparatus comprises means for supervising 110 and means for setting 120. The means for supervising 110 and means for setting 120 may be a supervising means and setting means, respectively. The means for supervising 110 and means for setting 120 may be a supervisor and setter, respectively. The means for supervising 110 and means for setting 120 may be a supervising processor and setting processor, respectively.

The means for supervising 110 supervises if an indication comprising a value of a management information (e.g. an administrative state) of an instance of a network function related to a slice is received (S110). If the indication is received (S110=yes), the means for setting 120 sets the value of the management information of the instance of the network function related to the slice according to the received indication (S120).

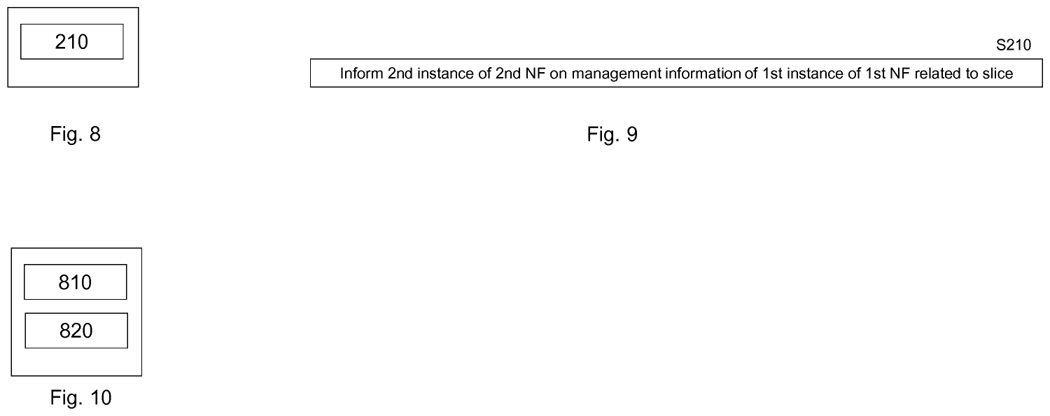

FIG. 8 shows an apparatus according to an example embodiment of the invention. The apparatus may be a network function (e.g. gNB, AMF, NSSF, or SMF) or an element thereof. FIG. 9 shows a method according to an example embodiment of the invention. The apparatus according to FIG. 8 may perform the method of FIG. 9 but is not limited to this method. The method of FIG. 9 may be performed by the apparatus of FIG. 8 but is not limited to being performed by this apparatus.

The apparatus comprises means for informing 210. The means for informing 210 may be an informing means. The means for informing 210 may be an informer. The means for informing 210 may be an informing processor.

The means for informing 210 informs a second instance of a second network function by a value information (S210). The value information informs on a value of a first management information (e.g. administrative state) of the first instance of the first network function related to the first slice. The second instance of the second network function is different from a first instance of a first network function. For example, the first network function is the same as the second network function and the first instance is different from the second instance, or the first network function is different from the second network function.

FIG. 10 shows an apparatus according to an example embodiment of the invention. The apparatus comprises at least one processor 810 and at least one memory 820 including computer program code, and the at least one processor 810, with the at least one memory 820 and the computer program code, being arranged to cause the apparatus to at least perform at least one of the methods according to FIGS. 5, 7, and 9 and related description.

Some example embodiments of the invention are described which are based on a 3GPP network. However, the invention is not limited to 3GPP networks of any generation (3G, 4G, 5G, etc.). It may be applied to other wireless and wireline networks applying slicing, too.

According to some example embodiments of the invention, one instance of a network function informs another instance of a same or a different network function on a value of the administrative state related to a particular slice if the value is modified. However, the invention is not limited to this case. For example, instead or in addition to informing the other instance in case of a modification, the former instance may inform the other instance periodically or due to some other event on the value of the administrative state related to the particular slice.

The definitions indicated in the present description are based on the current 3GPP standards. However, they do not limit the invention. Other definitions according to the same or a corresponding concept are applicable to some example embodiments of the invention, too.

One piece of information may be transmitted in one or plural messages from one entity to another entity. Each of these messages may comprise further (different) pieces of information.

Names of network elements, protocols, and methods are based on current standards. In other versions or other technologies, the names of these network elements and/or protocols and/or methods may be different, as long as they provide a corresponding functionality.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be embodied in the cloud.

According to the above description, it should thus be apparent that example embodiments of the present invention provide, for example, an instance of a network function, or a component thereof, an apparatus embodying the same, a method for controlling and/or operating the same, and computer program(s) controlling and/or operating the same as well as mediums carrying such computer program(s) and forming computer program product(s). According to the above description, it should thus be apparent that example embodiments of the present invention provide, for example, a management system such as a O&M system, or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof.

It is to be understood that what is described above is what is presently considered the preferred example embodiments of the present invention. However, it should be noted that the description of the preferred example embodiments is given by way of example only and that various modifications may be made without departing from the scope of the invention as defined by the appended claims.

1. An apparatus, comprising:
at least one processor; and
at least one memory including computer program code, the at least one memory and computer program code being configured, with the at least one processor, to cause the apparatus to:
set a value of a first administrative state of a network function related to a first slice; and
set a value of a second administrative state of the network function related to a second slice, wherein
the first slice is different from the second slice.

2. The apparatus according to claim 1, wherein the at least one memory and computer program code are further configured, with the at least one processor, to cause the apparatus to:
store a copy of the first administrative state of the network function related to the first slice;
supervise if an indication comprising a value of the first administrative state of the network function related to the first slice is received; and
set the copy of the value of the first administrative state of the first instance of the first network function related to the first slice according to the value comprised in the indication if the indication is received.

3. An apparatus, comprising:
at least one processor; and
at least one memory including computer program code, the at least one memory and computer program code being configured, with the at least one processor, to cause the apparatus to:
supervise if a first indication comprising a value of a first management information of a first instance of a first network function related to a first slice is received; and
set the value of the first management information of the first instance of the first network function related to the first slice according to the first indication if the first indication is received.

4. The apparatus according to claim 3, wherein
the first management information is a first administrative state; and wherein the at least one memory and computer program code are further configured, with the at least one processor, to cause the apparatus to:
monitor if a first request to the first instance of the first network function to provide a service for the first slice is received;
obtain the value of the first administrative state of the first instance of the first network function related to the first slice; and
instruct, in response to the first request, the first instance of the first network function to provide the service for the first slice according to the value of the first administrative state.

5. The apparatus according to claim 3, wherein
the first indication comprises an identifier of the first slice, and wherein the at least one memory and computer program code are further configured, with the at least one processor, to cause the apparatus to:
supervise if a second indication comprising a value of a second management information of the first instance of the first network function related to a second slice is received, wherein the second indication comprises an identifier of the second slice, and the identifier of the second slice is different from the identifier of the first slice;
set the value of the second management information of the first instance of the first network function related to the second slice according to the second indication if the second indication is received;
prohibit the value of the first management information from being set due to the receipt of the second indication.

6. The apparatus according to claim 5, wherein
the second management information is a second administrative state, and wherein at least one memory and computer program code are further configured, with the at least one processor, to cause the apparatus to:
to monitor if a second request to the first instance of the first network function to provide the service for the second slice is received;
obtain the value of the second administrative state of the first instance of the first network function, wherein the second administrative state is related to the second slice and not related to the first slice; and
instruct, in response to the second request, the first instance of the first network function to provide the service for the second slice according to the value of the second administrative state.

7. An apparatus, comprising:
at least one processor; and
at least one memory including computer program code, the at least one memory and computer program code being configured, with the at least one processor, to cause the apparatus to:
inform a second instance of a second network function different from a first instance of a first network function by a value information, wherein
the value information informs on a value of a first management information of the first instance of the first network function related to the first slice.

8. The apparatus according to claim 7, wherein the at least one memory and computer program code are further configured, with the at least one processor, to cause the apparatus to:
supervise if the value of the first management information of the first instance of the first network function related to the first slice is modified; and
trigger the apparatus to inform the second instance of the second network function by the value information if the value of the first management information of the first instance of the first network function related to the first slice is modified.

9. The apparatus according to claim 7, wherein the at least one memory and computer program code are further configured, with the at least one processor, to cause the apparatus to:
decide, based on a stored relationship between the first network function and the second network function, if any instance of the second network function is to be informed by the value information; and
inhibit the apparatus from informing the second instance of the second network function by the value information if, according to the stored relationship, no instance of the second network function is to be informed by the value information.

10. The apparatus according to claim 7, wherein the first management information is a first administrative state, and wherein the at least one memory and computer program code are further configured, with the at least one processor, to cause the apparatus to:
monitor if a first request to the first instance of the first network function to provide a service for the first slice is received;
obtain a value of the first administrative state of the first instance of the first network function related to the first slice; and
instruct, in response to the first request, the first instance of the first network function to provide the service for the first slice according to the value of the first administrative state.

11. The apparatus according to claim 10, wherein
the first request comprises an identifier of the first slice; and wherein the at least one memory and computer program code are further configured, with the at least one processor, to cause the apparatus to:
monitor if a second request to the first instance of the first network function to provide the service for a second slice is received, wherein the second request comprises an identifier of the second slice, and the identifier of the second slice is different from the identifier of the first slice;
obtain a value of a second administrative state of the first instance of the first network function, wherein the second administrative state is related to the second slice and not related to the first slice; and
instruct, in response to the second request, the first instance of the first network function to provide the service for the second slice according to the value of the second administrative state.

12. The apparatus according to claim 3, wherein the first management information is at least one of a first administrative state of the first instance of the first network function related to the first slice, an operational state of the first instance of the first network function related to the first slice, and a status regarding a test of the first instance of the first network function related to the first slice.

13. The apparatus according to claim 3, wherein either
the first network function is the same as the second network function and the first instance is different from the second instance, or
the first network function is different from the second network function.

14. The apparatus according to claim 4, wherein
the first network function is a base station function;
the first management information is a first administrative state; and at least one of
if the first administrative state is locked and a third administrative state of a default slice is unlocked, the base station function provides the service related to the default slice in response to the first request, and
if the first administrative state is locked and the third administrative state of the default slice is locked, the base station function rejects the first request.

15. The apparatus according to claim 4, wherein
the first network function is an access and mobility function;
the first management information is a first administrative state; and, if the first administrative status is locked, at least one of
the access and mobility function does not request a further service regarding the first slice from a further network function based on the first request;
the access and mobility function rejects the first request; and
the access and mobility function removes the first slice from a terminal for which the service is requested by the first request.

16. The apparatus according to claim 4, wherein
the first network function is a network slice selection function;
the first management information is a first administrative state; and, if the first administrative state is locked, at least one of
the network slice selection function does not request a further service regarding the first slice from a further network function based on the first request; and
the network slice selection function informs that the first slice is not available.
